(19) United States
(12) Patent Application Publication
(10) Pub. No.: US 2008/0011845 A1
(43) Pub. Date: Jan. 17, 2008

(54) PRINTING DEVICE FOR A VOTING BOOTH, VOTING APPARATUS, AND METHOD OF PROVIDING SECURE ELECTRONIC SELECTION BY A USER

(75) Inventor: Ming Kun GUO, Taipei (TW)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: APS-BOMC, INC DBA APS AMERICA, Carson, CA (US)

(21) Appl. No.: 11/778,712

(22) Filed: Jul. 17, 2007

Related U.S. Application Data
(60) Provisional application No. 60/807,612, filed on Jul. 17, 2006.

(51) Int. Cl. G07C 13/00

(52) U.S. Cl. 235/386; 705/12

(57) ABSTRACT

A printing device for a voting booth comprises a printing mechanism, a viewing window placed after the printing mechanism on the path of the substrate so as to present the printed substrate to the voter, and a dispensing mechanism for dispensing the printed substrate. A voting apparatus for secure electronic voting comprises an interface for displaying information to the voter and receiving a selection by the voter, a record generator for generating a physical record of the selection, a display for displaying the record to the voter, and a dispenser for dispensing the record. A method of providing secure electronic selection by a user comprises providing information to the user; receiving an electronic instruction from the user; generating a physical record of the instruction; providing a visual display of at least part of the record to the user; and dispensing the record.

The invention concerns a printing device for a voting booth, a voting apparatus, and a method of providing secure electronic selection by a user, such as a voter.

### BACKGROUND OF THE INVENTION

Various printing apparatuses are used to print receipts and other information in kiosks or vending machines, such as gas pumps. Generally, the kiosk or vending machine comprises an interface with the user, for example, a display screen where a range of services is offered, and a keyboard where the user inputs an order, for example, the type of gasoline to be dispensed, or the manner of payment, i.e., cash, credit card, etc. The kiosk or vending machine also comprises usually a printing mechanism that prints a receipt, which is then dispensed to the user. For convenience, the printing mechanism is often a thermal printing device that prints successive receipts from a roll of paper or other substrate. Individual receipts are cut from the paper roll before or at the time of being dispensed to the user.

### SUMMARY OF THE INVENTION

Generally, a voting machine is provided in the form of an electronic voting booth, which comprises an interface with the user, i.e., the voter, and a device for recording the voter's selection or transmitting it to a further processing station. In particular, an electronic voting booth avoids the manipulation of paper ballots by the voters, and thus, it simplifies greatly the voting process. However, a problem with electronic voting machines is that, if the voter receives a confirmation of his choice only through an electronic confirmation, or no confirmation at all, this may raise questions as to whether the vote actually recorded by the machine is the same as the voter's selection.

Thus, an objective of the invention is to assist a voter in making his or her choice, so as to provide a secure electronic voting. Another objective of the invention is to provide a physical record of the voters' choices, which is advantageously anonymous.

Thus, in one aspect, the invention provides a printing device for a voting booth, comprising, on a path of printing substrate:

a printing mechanism adapted to print on a substrate information selected by a voter,

a viewing window placed after the printing mechanism on the path of the substrate so as to present the printed substrate to the voter, and

a dispensing mechanism for dispensing the printed substrate.

In another aspect, the invention provides a voting apparatus for secure electronic voting by a voter, comprising:

an interface with the voter for displaying information to the voter and receiving a selection by the voter,

a record generator for generating a physical record of the selection,

a display for displaying the physical record to the voter, and

a dispenser for dispensing the physical record.

In still another aspect, the invention provides a method of providing secure electronic selection by a user, comprising:

providing information to the user;

receiving an electronic instruction from the user;

generating a physical record of the instruction;

providing a visual display of at least part of the physical record to the user; and

dispensing the physical record.

### BRIEF DESCRIPTION OF THE DRAWINGS

Particular embodiments of the invention will now be described with reference to a non-limiting example, in reference to the annexed drawings in which:

FIG. 1 is a perspective view from above of a printing device according to the invention, showing a path of the paper in the device;

FIG. 2 is a longitudinal cross-section view of the device of FIG. 1;

FIG. 3 is a perspective view from below of the device of FIG. 1.

FIG. 4 is a partial side view showing details of a random dispatching mechanism of the printing device according to the invention.

### DETAILED DESCRIPTION OF PARTICULAR EMBODIMENTS

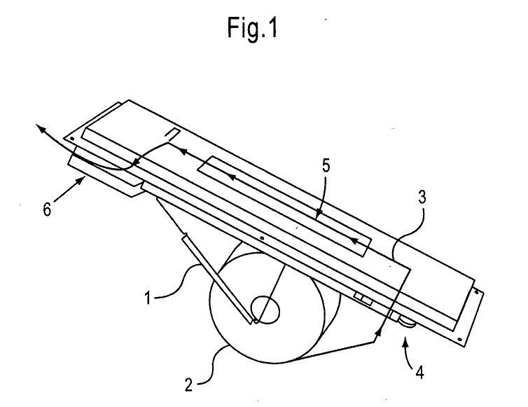

The exemplary printing device shown on FIG. 1 comprises a reserve 1 for a source of printing substrate, i.e., a paper roll 2, which follows a circulation path 3 along the device. In a circulation direction of the paper, the device comprises a printing mechanism 4 for printing a voter's selection on the paper, a viewing area 5 for presenting the printed record of the voter's selection to the voter for verification, and a dispensing mechanism 6 for dispensing the printed record. The viewing area 5 can be a transparent window panel of a rectangular shape, as shown on FIG. 1, or any other shape. The viewing window makes it possible for a voter to view the printed ballot after printing by the printing mechanism.

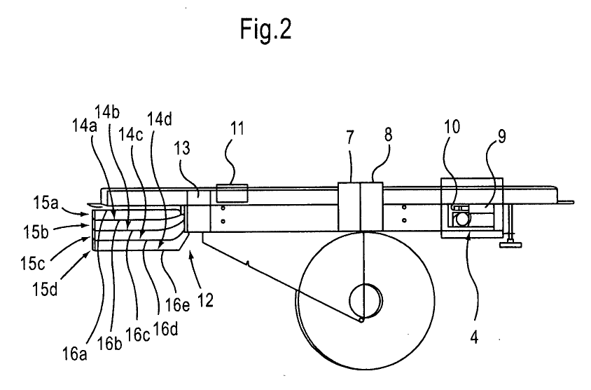

More specifically, as shown on FIG. 2, the device has a connection 7 for connecting the device to a source of energy, for example, a DC circuit (with or without DC/DC converter). In the alternative, the device can be battery-powered, or connected to another source of energy, for example, an AC circuit, for example, through an AC/DC transformer. The device also has an interface 8 for transferring instruction from the voting booth, or to and from the voting booth, to control the printing device. This interface is, for example, through a parallel interface (centronics), a USB port, etc.

The printing mechanism 4 is associated to a control board 9 for controlling the mechanism, and to a paper cutter 10, which is disposed immediately after the printing mechanism along the path of the paper.

The dispensing mechanism 6 comprises a presenting mechanism 11 and a random dispatch mechanism 12. More specifically, the presenting mechanism 11 can comprise rollers that pinch the front edge of the paper, to move the paper along the circulation path. At least one of the rollers is a driven roller. The presenting mechanism is advantageously placed immediately after the viewing area, so as to participate in a precise control of the position of the paper in the viewing area 5.

The random dispatch mechanism 12 comprises a paper path actuator 13 and a plurality of exit paths 14a, 14b, 14c, 14d for the paper, these respective exit paths having spatially distributed outlets 15a, 15b, 15c, 15d. The paper path actuator 13 operates to distribute successive ballots into the exit paths 14a-d, preferably in a partially or completely randomized manner, so that successive ballots do not accumulate in a particular order at the exit of the printing device.

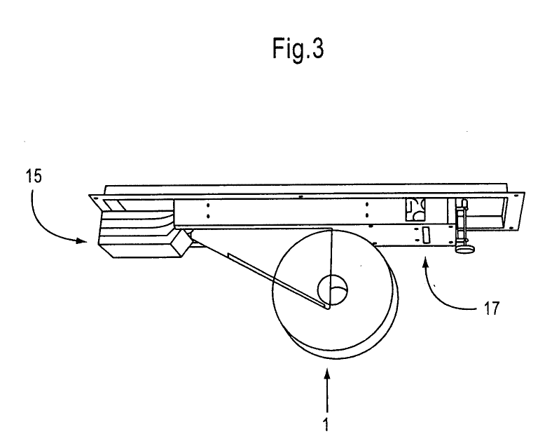

For example, the exit paths 14 are formed by channels in a stack of plates 16a, 16b, 16c, 16d, 16e, and the outlets 15 are distributed perpendicularly to a general paper path direction, as shown on FIGS. 2 and 3. In variant, the outlets 15 can be distributed along another direction, or along several directions, or in a plane, for example, using staggered outlets. Thus, the fall trajectory of a ballot as it is ejected from an outlet is different according to at least two particular outlets. If successive ballots are distributed among the various exit paths in a randomized manner, their fall trajectory is consequently randomized, and the order of printing the ballots cannot be determined from a pile of ballot formed at the exit of the printing mechanism.

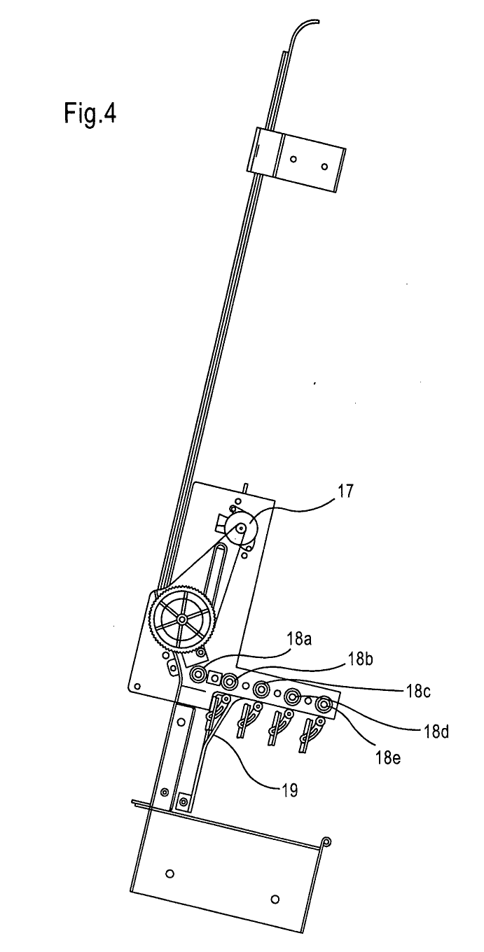

As shown in FIG. 4, an exemplary random dispatch mechanism comprises a first set of rollers for picking up a front edge of the paper and advancing the paper, and a second set of rollers for directing the paper into one of a plurality of dispatch paths. A single motor can be provided for driving one or several rollers in both sets of rollers, for example, through appropriately disposed gears. On FIG. 4, the motor 17 drives the pick-up roller(s) via a belt (visible on FIG. 4) and the set of five successive rollers 18a, b, c, d, e along an upstream side of the exit paths via gears on the opposite side (not shown on FIG. 4). A flexible element is disposed in correspondence with each slot, such as a sheet of flexible material which can be fixed to an upstream wall of the exit slot and oriented downstream along and toward the line of rollers 18 so as to form an angle with the paper path (only the sheet 19 in the first slot is shown on FIG. 4). The sheet may be in contact with the rollers or a belt mounted on the rollers. Thus, the flexible material of each slot allows the paper to advance along rollers 18, but not to go back upstream, except to enter the corresponding exit slot.

To select an exit slot randomly, the motor is driven so as to pick up the paper and advance it along the rollers 18 until the back edge of the paper is located beyond the flexible element of one slot (which has been selected randomly). Then, the motor is reversed, so that the back edge of the paper is directed into the corresponding slot and exits through the corresponding outlet.

For example, each dispatch path is associated with a number. A random counter generates a number each time a user generates a confirmation or rejection instruction. The picking rollers and the dispatch rollers are moved to direct the paper along rollers 18 until the back edge of the paper is presented beyond the flexible element of the dispatch path corresponding to the randomly selected number. The motor is then reversed to direct the paper to the corresponding outlet. In the case of the last slot (toward roller 18e), the flexible element can be absent, and the paper can be dispensed without reversing the motor.

The path of the paper can be completely enclosed in the printing device, or the paper can be dispensed from the paper roll into a printing mechanism side of the device at the upstream side through a paper inlet 17 and out of the exit side of the printing device trough the outlets 15 at the downstream side of the random dispatch mechanism, as shown in FIG. 3. Thus, in the device, the printing mechanism 4 is placed toward one end of the viewing area 5 or window, at the upstream side, and the presenting mechanism 6 is placed toward another end of the viewing area, at the downstream side of the paper path.

The printing device is controlled from the voting booth through a control circuit of the printing device which is intended to be connected to the voting booth. The control circuit is adapted, more specifically, for the control of some or all of the printing mechanism, cutting (separating) mechanism, dispenser mechanism, and dispatch mechanism. In variants, one or several of these can be controlled by a control unit of the printing device. In particular, the dispatch mechanism is advantageously a self-controlled unit, so as to generate a random paper path for each ballot.

A description of the operation of the printing device follows.

Prior to the start of the voting procedure, for example, prior to election day, a technician loads paper into the printer device from the paper roll.

At the time of voting, a voter approaches the voting booth and uses the voter interface of the voting booth, usually a touch screen, or a combination of display screen and keyboard, to input a vote, i.e., a particular selection, order, or instruction.

When the voter finishes voting on the touchscreen, a signal is sent to print the ballot.

The signal is sent to the printer mechanism through the control interface.

The printer mechanism prints the ballot, and advances the ballot to the viewing area (viewing window). In this case, the ballot is stopped when it hits the presenter located just beyond the viewing window, so that at least a substantial part of the ballot, usually, at least the portion on which is printed a record of the voter's choice, remains visible through the viewing window.

The voter can review the ballot through the viewing window. After reading, the voter presses a confirmation button of the voting booth to confirm his or her vote. If the vote is confirmed, the printer prints a confirmation notice, for example, the word “CONFIRMED,” or a bar code (for example, a 2D bar code) containing other information regarding the voter's selection. If the vote is rejected, the printer prints a rejection notice, for example the word “REJECTED” in conspicuous letters.

The cutting mechanism then cuts the paper to separate the ballot, including the record of the voter's selection and the confirmation or rejection notice, from the paper roll.

The dispenser then advances the paper ballot out of the printing mechanism. Generally, the paper is directed into a secure ballot box.

In the example shown, the paper ballot is directed to the random dispatching mechanism, which distributes the ballot spatially into the ballot box by selecting spatially distributed paths and corresponding outlets for successive ballots in a randomized manner, so that a pile of successive ballots does not form in the ballot box. Thus, the voter's ballot is securely anonymous.

In a variant, instead of, or in addition to, the notice printing, the ballot is directed into different exit paths according to the review notice provided by the user, so that, for example, rejected ballots are directed to a rejected ballot box and confirmed ballots are directed to a confirmed ballot box. In that case, a random dispatching mechanism can be disposed on the path(s) of one of the boxes, preferably the confirmed ballot box, or boxes.

It will be recognized that the various units on the path of the substrate can be omitted or rearranged in the order desired. In particular, the printing device can comprise a random dispatch mechanism independently from the other elements described above. Also, the printing device can comprise a viewing area independently from the presence or not of other portions.

Finally, the device and apparatus described above, and the method of secure voting by a user can be adapted to function for recording other types of instructions by a user, such as purchase, order, payment, etc. For example, the device, apparatus and method can be adapted to so-called kiosks or point-of-sale apparatuses, in which viewing and/or confirmation of the user's instruction on a physical substrate is desirable, or in which an anonymous physical record of the user's instruction is desired. Viewing of a physical record can be directly through an open window area, through a viewing window panel, or through a display device such as a window display screen. For example, a scanner in the viewing area is connected to a display screen displaying an image of the printed substrate.

1. Printing device for a voting booth, comprising, on a path of printing substrate:
a printing mechanism adapted to print on a substrate information selected by a voter,
a viewing window placed after the printing mechanism on the path of the substrate so as to present the printed substrate to the voter, and
a dispensing mechanism for dispensing the printed substrate.

2. The device of claim 1, wherein the viewing window is a transparent panel.

3. The device of claim 1, comprising a reserve for the printing substrate.

4. The device of claim 2, wherein the reserve is a container for a paper roll.

5. The device of claim 4, further comprising a separating mechanism adapted to provide separate records of each voter's selected information.

6. The device of claim 1, wherein the dispensing mechanism comprises a plurality of spatially distributed outlets, and a random dispatch mechanism adapted to distribute successive substrates to the outlets in a randomized manner.

7. The device of claim 6, wherein the dispensing mechanism comprises a plurality of separate paths leading to the outlets, and a distribution mechanism for distributing successive substrates among the paths.

8. The device of claim 7, wherein the respective paths are formed by channels in a stack of plates.

9. Voting apparatus for secure electronic voting by a voter, comprising:
an interface with the voter for displaying information to the voter and receiving a selection by the voter,
a record generator for generating a physical record of the selection,
a display for displaying the physical record to the voter, and
a dispenser for dispensing the physical record.

10. The apparatus of claim 9, wherein
the record generator is a printing mechanism, and
the physical record display is a transparent window.

11. The apparatus of claim 9, wherein the interface is adapted to receive a confirmation of the selection by the user during or after display of the physical record by the display.

12. The apparatus of claim 9, comprising a source of substrate for generating respective physical records.

13. The apparatus of claim 12, wherein the source of substrate is a paper roll.

14. The apparatus of claim 9, comprising a separator for separating successive substrates or physical records.

15. The apparatus of claim 9, wherein the dispenser comprises a random dispatch mechanism adapted to distribute spatially successive physical records in a randomized manner at the exit of the dispenser.

16. The apparatus of claim 15, wherein the random dispatch mechanism includes a plurality of paths with spatially staggered outlets

17. The apparatus of claim 16, wherein the paths are defined by channels in a stack of plates.

18. The apparatus of claim 15, wherein the dispenser comprises an exit path actuator adapted to distribute successive physical records to the outlets in a randomized manner.

19. Method of providing secure electronic selection by a user, comprising:
providing information to the user;
receiving an electronic instruction from the user;
generating a physical record of the instruction;
providing a visual display of at least part of the physical record to the user; and
dispensing the physical record.

20. The method of claim 19, comprising, during or after providing the visual display of the physical record:
receiving a confirmation of the selection by the user.

21. The method of claim 19, comprising
providing successive physical records as physically separate elements.

22. The method of claim 21, comprising
dispensing a plurality physical records with a spatial distribution, wherein the spatial distribution of successive records is randomized.

23. The method of claim 19, wherein the physical records are generated by printing on a substrate.

24. The method of claim 23, wherein the physical records are printed on paper from a paper roll.

25. The method of claim 24, wherein each printed record is separated from the roll by cutting.

26. The method of claim 19, wherein the physical record is displayed to the user through a transparent window.

27. The method of claim 19, comprising providing separate physical records including user instruction information and a confirmation or rejection notice information.

28. The method of claim 27, wherein the user instruction information and the confirmation or rejection notice information are recorded in successive steps.

29. The method of claim 28, wherein the confirmation or rejection notice information is recorded during or after display of the physical record.
